(19) United States
(12) Patent Application Publication
(10) Pub. No.: US 2017/0185118 A1
(43) Pub. Date: Jun. 29, 2017

(54) CONTROL METHOD, INFORMATION PROCESSING APPARATUS, AND STORAGE MEDIUM

(71) Applicant: FUJITSU LIMITED, Kawasaki-shi (JP)

(72) Inventor: Atsushi Iwata, Kawasaki (JP)

(73) Assignee: FUJITSU LIMITED, Kawasaki (JP)

(21) Appl. No.: 15/370,229

(22) Filed: Dec. 6, 2016

(30) Foreign Application Priority Data
Dec. 25, 2015 (JP) 2015-253374

(51) Int. Cl. G06F 1/20; G05B 19/042

(52) U.S. Cl. CPC G06F 1/206; G05B 19/042; G05B 2219/21156

(57) ABSTRACT

A control method includes calculating a switching temperature indicating a maximum outside air temperature at which a temperature of the unknown electronic component attached within an enclosure does not exceed the operation-guaranteed temperature, based on a temperature of an electronic component for which a relationship between power consumption and a temperature of the electronic component is already known, the temperature of the electronic component corresponding to maximum power consumption of an electronic component for which a relationship between power consumption and the temperature of the electronic component is unknown, and on an operation-guaranteed temperature of the unknown electronic component; and setting the number of revolutions of a fan to a value for suppressing the temperature of the unknown electronic component to a level less than or equal to the operation-guaranteed temperature, when an outside air temperature exceeds the switching temperature during attachment of the unknown electronic component within the enclosure.

### CROSS-REFERENCE TO RELATED APPLICATION

This application is based upon and claims the benefit of priority of the prior Japanese Patent Application No. 2015-253374, filed on Dec. 25, 2015, the entire contents of which are incorporated herein by reference.

### FIELD

The embodiments discussed herein are related to a control method, an information processing apparatus, and a storage medium.

### BACKGROUND

An information processing apparatus such as a server includes a fan for releasing, to the outside of an enclosure, heat generated by an electronic device included in the enclosure. The number of revolutions of the fan is controlled based on a temperature detected by a temperature sensor provided within the enclosure. In, for example, an information processing apparatus in which electronic devices are mounted so as to be detachable, a control unit to control the number of revolutions of a fan receives, from a temperature sensor, information indicating a temperature within an enclosure. In addition, the control unit receives, from each of the electronic devices, information indicating the amount of heat generation of the relevant electronic device mounted in the information processing apparatus. Based on the received information, the control unit sets a temperature at which the number of revolutions of the fan is to be switched from a low revolution state to a high revolution state. A control device sets the temperature at which the number of revolutions of the fan is to be switched from the low revolution state to the high revolution state, to, for example, a temperature that decreases with an increase in the amount of heat generation of the electronic devices mounted in the information processing apparatus (see, for example, International Publication Pamphlet No. WO 2013/151117).

However, in a case where an electronic device having no function of outputting information indicating the amount of heat generation is mounted in the information processing apparatus, the control device receives, from the relevant electronic device, no information indicating the amount of heat generation. Therefore, it is difficult to control, based on information of a temperature and information indicating the amount of heat generation, the number of revolutions of the fan. In a case where, for example, based on receiving, from the relevant electronic device, no information indicating the amount of heat generation, the control device fixes the number of revolutions of the fan at a maximum value, power consumption is increased and a noise becomes loud, compared with a case of controlling the number of revolutions of the fan. In view of the above, it is desirable that, in a case where an unsupported electronic component is mounted, it is possible to suppress an increase in the power consumption of the information processing apparatus.

### SUMMARY

According to an aspect of the invention, a control method executed by a processor included in an information processing apparatus, the control method includes calculating a switching temperature indicating a maximum outside air temperature at which a temperature of the unknown electronic component attached within an enclosure does not exceed the operation-guaranteed temperature, based on a temperature of an electronic component for which a relationship between power consumption and a temperature of the electronic component is already known, the temperature of the electronic component corresponding to maximum power consumption of an electronic component for which a relationship between power consumption and the temperature of the electronic component is unknown, and on an operation-guaranteed temperature of the unknown electronic component; and setting the number of revolutions of a fan to introduce outside air into the enclosure to a value for suppressing the temperature of the unknown electronic component to a level less than or equal to the operation-guaranteed temperature, when an outside air temperature exceeds the switching temperature during attachment of the unknown electronic component within the enclosure.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an embodiment of each of an information processing apparatus, a control method for the information processing apparatus, and a control program for the information processing apparatus;

FIG. 2 is a diagram illustrating another embodiment of each of the information processing apparatus, the control method for the information processing apparatus, and the control program for the information processing apparatus;

FIG. 3 is a diagram illustrating an example of control of the number of revolutions in a normal control mode in each of fans illustrated in FIG. 2;

FIG. 4 is a diagram illustrating an example of a relationship between power consumption of a card mounted in a server illustrated in FIG. 2 and an ambient temperature of the card;

FIG. 5 is a diagram illustrating examples of electrical characteristic specifications of each of unsupported cards mounted in the server illustrated in FIG. 2;

FIG. 6 is diagrams each illustrating an example of control of the number of revolutions of each of fans of a server in which a card illustrated in FIG. 5 is mounted;

FIG. 7 is a diagram illustrating examples of electrical characteristic specifications of each of other unsupported cards mounted in the server illustrated in FIG. 2;

FIG. 8 is diagrams each illustrating an example of control of the number of revolutions of each of fans of a server in which an unsupported card illustrated in FIG. 7 is mounted;

FIG. 9 is a diagram illustrating an example of an operation of a basic input/output system (BIOS) illustrated in FIG. 2; and

FIG. 10 is a diagram illustrating an example of an operation of a baseboard management controller (BMC) illustrated in FIG. 2.

### DESCRIPTION OF EMBODIMENTS

Hereinafter, embodiments will be described by using drawings.

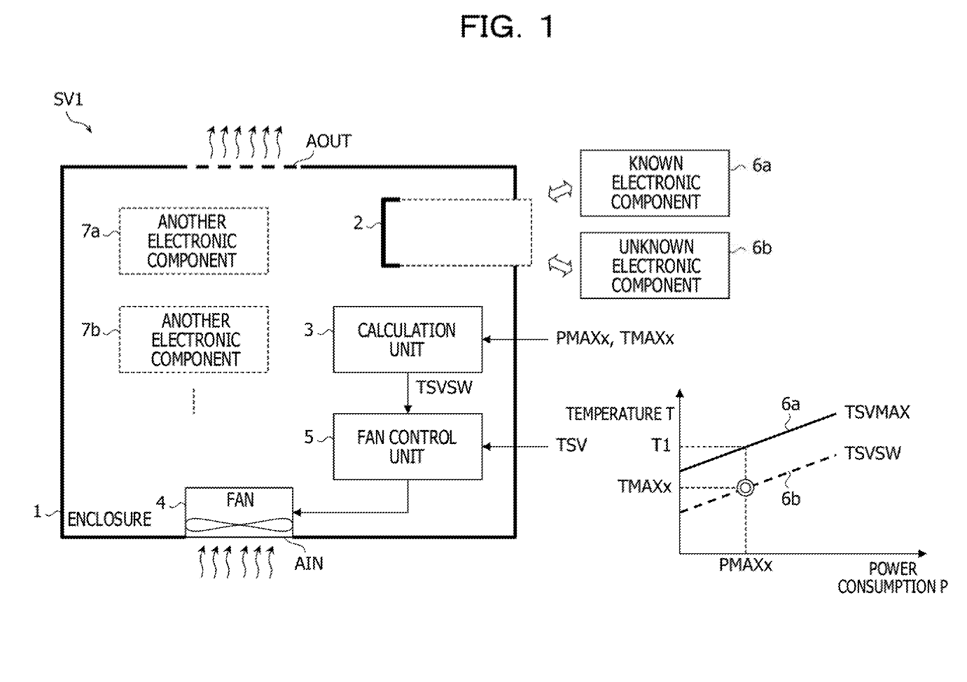

FIG. 1 illustrates an embodiment of each of an information processing apparatus, a control method for the information processing apparatus, and a control program for the information processing apparatus. A server SV1 illustrated in FIG. 1 includes an enclosure 1, an attachment portion 2 provided within the enclosure 1, a calculation unit 3, a fan 4, and a fan control unit 5. The attachment portion 2, the calculation unit 3, the fan 4, and the fan control unit 5 are mounted in, for example, a substrate such as a motherboard provided within the enclosure 1. The server SV1 is an example of the information processing apparatus.

An electronic component 6a or an electronic component 6b is attached to the attachment portion 2 so as to be detachable. The attachment portions 2 may be provided within the enclosure 1. The electronic component 6a has a specified relationship between power consumption P and a temperature T within the enclosure 1 in a case of operating in the attachment portion 2 while being attached thereto. The relationship of the electronic component 6a between the power consumption P and the temperature T within the enclosure 1 is specified by being measured by a vendor or the like of the server SV1. A solid line, which is illustrated in FIG. 1 and which indicates the relationship between the power consumption P and the temperature T, indicates a characteristic of the electronic component 6a within the enclosure 1 at a maximum value TSVMAX of an outside air temperature TSV permissible for the server SV1. The electronic component 6a is an example of a known electronic component for which a relationship between power consumption and a temperature within the enclosure 1 is already known.

The electronic component 6b has no specified relationship between power consumption and a temperature within the enclosure 1 in a case of operating in the attachment portion 2 while being attached thereto. In other words, the electronic component 6b is not supported by the vendor of the server SV1. Maximum power consumption PMAXx and an operation-guaranteed temperature TMAXx of the electronic component 6b are specified as electrical characteristic specifications by a vendor or the like of the electronic component 6b. The electronic component 6b is an example of an unknown electronic component for which a relationship between power consumption and a temperature within the enclosure 1 is unknown.

Based on the characteristic (the solid line) of the electronic component 6a between the power consumption P and the temperature T, specified in advance, the calculation unit 3 calculates a temperature T1 of the electronic component 6a in a case where the electronic component 6a consumes the same electric power as the maximum power consumption PMAXx of the electronic component 6b. Furthermore, based on the calculated temperature T1 and the operation-guaranteed temperature TMAXx of the electronic component 6b, the calculation unit 3 calculates a maximum outside air temperature TSVSW at which a temperature of the electronic component 6b attached to the attachment portion 2 does not exceed the operation-guaranteed temperature TMAXx. The calculation unit 3 receives, from, for example, the outside of the server SV1, the maximum power consumption PMAXx and the operation-guaranteed temperature TMAXx of the electronic component 6b. Hereinafter, the maximum outside air temperature TSVSW is also called a switching temperature TSVSW. The calculation unit 3 outputs the calculated switching temperature TSVSW to the fan control unit 5.

The calculation unit 3 may include a holding unit to hold, as a mathematical expression or a table, the relationship between the power consumption P and the temperature T of the electronic component 6a. The calculation unit 3 may include a holding unit to hold the maximum power consumption PMAXx and the operation-guaranteed temperature TMAXx of the electronic component 6b, received from the outside of the server SV1.

The fan 4 is provided in an air inlet AIN. Based on control performed by the fan control unit 5, the fan 4 introduces outside air from the air inlet AIN into the enclosure 1, in order to release, to the outside of the enclosure 1, heat generated within the enclosure 1. The outside air introduced from the air inlet AIN into the enclosure 1 absorbs heat generated by the electronic component 6a (or 6b), other electronic components 7a and 7b, and so forth with in the enclosure 1, thereby being heated. In addition, the heated outside air is released from an exhaust outlet AOUT of the enclosure 1. The fan 4 may be provided in the exhaust outlet AOUT, thereby releasing, from the exhaust outlet AOUT, the outside air introduced from the air inlet AIN and heated.

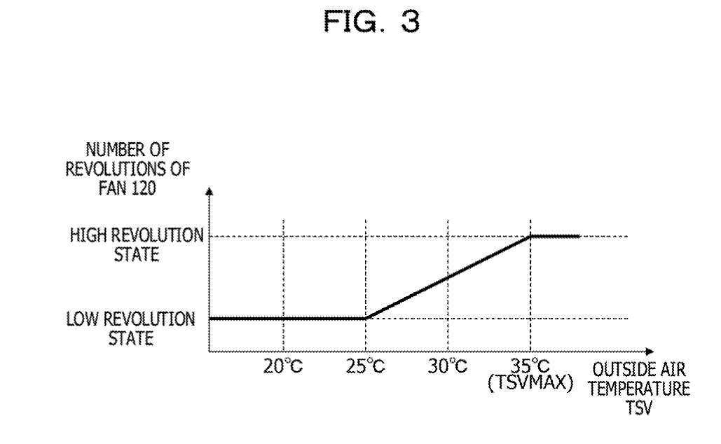

The fan control unit 5 executes, for example, variable control for increasing the number of revolutions of the fan 4 in a case where the outside air temperature TSV rises and for decreasing the number of revolutions of the fan 4 in a case where the outside air temperature TSV falls. In other words, in the same way as in FIG. 3 described later, the fan control unit 5 executes variable control for changing the number of revolutions of the fan 4 between a low revolution state and a high revolution state in accordance with the outside air temperature TSV. In the example illustrated in FIG. 1, the fan control unit 5 receives, from the outside of the enclosure 1, temperature information indicating the outside air temperature TSV. However, the fan control unit 5 may receive the temperature information indicating the outside air temperature TSV, from a temperature sensor provided near the air inlet AIN within the enclosure 1.

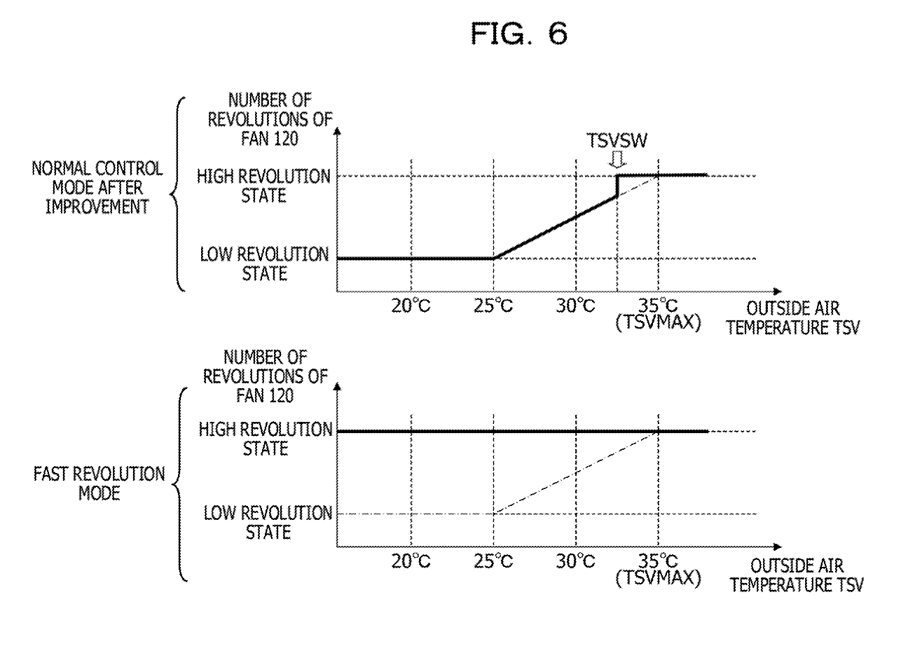

In a case where the outside air temperature TSV exceeds the switching temperature TSVSW during attachment of the electronic component 6b to the attachment portion 2, the fan control unit 5 stops the variable control for changing the number of revolutions of the fan 4 in accordance with the outside air temperature TSV. In addition, the fan control unit 5 sets the number of revolutions of the fan 4 to a value for suppressing the temperature of the electronic component 6b to a level less than or equal to the operation-guaranteed temperature TMAXx. The number of revolutions of the fan 4, which suppresses the temperature of the electronic component 6b to a level less than or equal to the operation-guaranteed temperature TMAXx, is the maximum settable number of revolutions, for example. Control of the number of revolutions of the fan 4, executed based on the switching temperature TSVSW, is the same as an operation in a normal control mode after improvement, illustrated in upper side of FIG. 6.

From this, even in a case where the electronic component 6b, for which no relationship between the power consumption P and the temperature T within the enclosure 1 is specified, is mounted in the server SV1, it is possible to control the number of revolutions of the fan 4, thereby suppressing the temperature of the electronic component 6b to a level less than or equal to the operation-guaranteed temperature TMAXx. Compared with a case of fixing, based on mounting of the electronic component 6b in the server SV1, the number of revolutions of the fan 4 at a maximum value, it is possible to reduce the power consumption of the fan 4, and it is possible to reduce the noise of the fan 4. In other words, compared with a case of fixing, based on the mounting of the unsupported electronic component 6b in the server SV1, the number of revolutions of the fan 4 at the maximum value, it is possible to reduce the power consumption of the server SV1, and it is possible to reduce the noise of the server SV1.

The calculation unit 3 and the fan control unit 5 may be realized by hardware such as a logic LSI mounted within the enclosure 1. Alternatively, the calculation unit 3 and the fan control unit 5 may be realized by a program executed by a processor such as a central processing unit (CPU), mounted within the enclosure 1. In a case where the server SV1 includes a baseboard management controller (BMC) to manage the number of revolutions of the fan 4, a power-supply voltage, and so forth, the calculation unit 3 and the fan control unit 5 may be realized by a program executed by the BMC.

As above, in the embodiment illustrated in FIG. 1, compared with a case of fixing, based on the mounting of the unsupported electronic component 6b in the server SV1, the number of revolutions of the fan 4 at the maximum value, it is possible to reduce the power consumption of the fan 4, and it is possible to reduce the noise of the fan 4. As a result, in a case of mounting the unsupported electronic component 6b in the server SV1, it is possible to suppress an increase in the power consumption of the server SV1, and it is possible to suppress an increase in the noise of the server SV1.

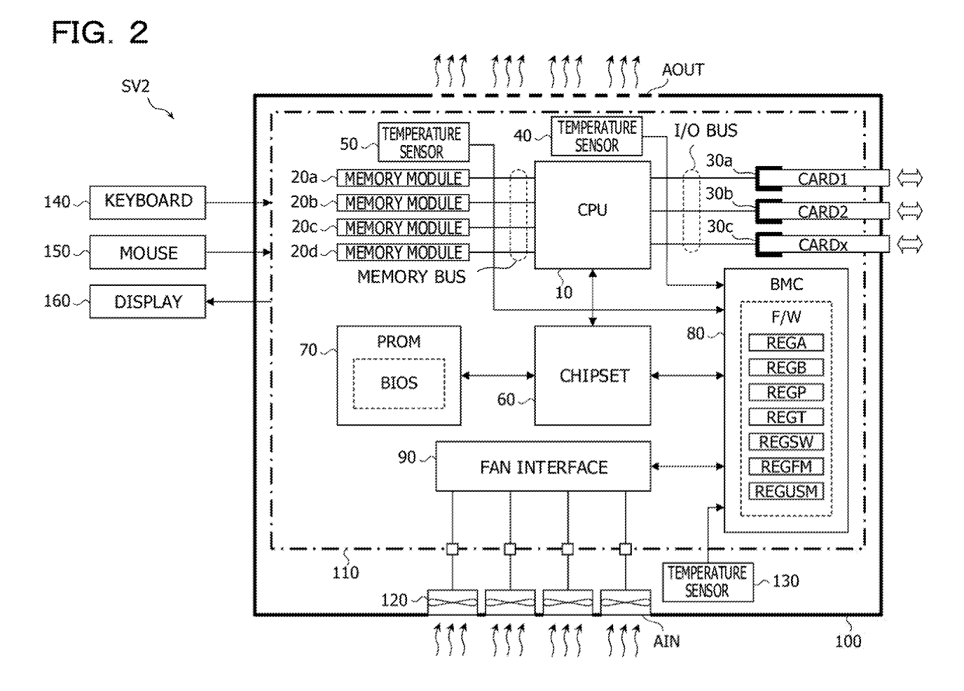

FIG. 2 illustrates another embodiment of each of the information processing apparatus, the control method for the information processing apparatus, and the control program for the information processing apparatus. The same symbol is assigned to the same element as or an element similar to an element described in the embodiment illustrated in FIG. 1, and the detailed description thereof will be omitted.

A server SV2 illustrated in FIG. 2 includes an enclosure 100, which incorporates a motherboard 110, fans 120, and a temperature sensor 130, and user interfaces such as a keyboard 140, a mouse 150, and a display 160, coupled to the motherboard 110. The server SV2 is an example of the information processing apparatus.

The motherboard 110 includes a processor such as a CPU 10, storage devices such as memory modules 20 (20a, 20b, 20c, and 20d), card slots 30 (30a, 30b, and 30c), and temperature sensors 40 and 50. The motherboard 110 includes a chipset 60, a programmable read only memory (PROM) 70, a BMC 80, and a fan interface 90.

The CPU 10 executes a basic program such as a basic input/output system (BIOS). The CPU 10 executes a user program and so forth stored in the memory modules 20, thereby realizing functions of the server SV2.

The memory modules 20 each include a printed-circuit board equipped with semiconductor memory chips such as dynamic random access memory (DRAM) chips. The memory modules 20 are coupled to the motherboard 110 via sockets, not illustrated. Furthermore, the memory modules 20 are coupled to the CPU 10 via a memory bus. Programs, data, and so forth to be stored in the memory modules 20 are transferred by an external storage device such as, for example, a hard disk drive (HDD) or a solid state drive (SSD), not illustrated and coupled to the motherboard 110.

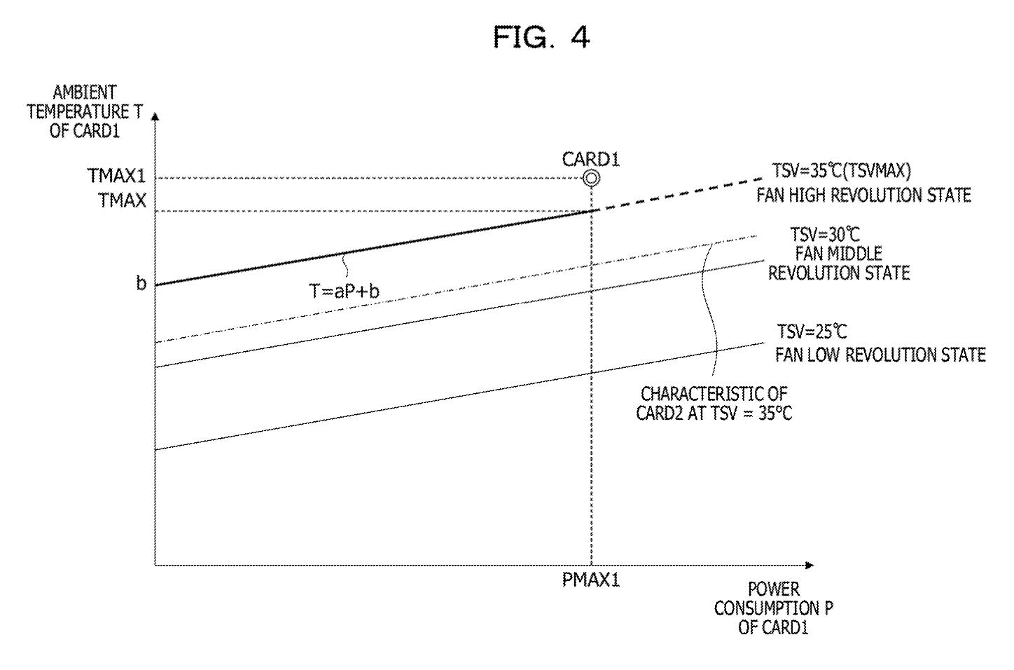

The card slots 30 are coupled to the CPU 10 via an input/output (I/O) bus. The I/O bus is a peripheral component interconnect (PCI) bus or a PCI express (registered trademark) bus. The I/O bus may be a bus based on another standard. Cards CARD (CARD1, CARD2, and CARDx, for example) are attached to the card slots 30 (30a, 30b, and 30c) so as to be detachable. The cards CARD1, CARD2, and CARDx each include an interface based on, for example, a PCI standard. In other words, the cards CARD1, CARD2, and CARDx are so-called PCI cards. The cards CARD1, CARD2, and CARDx may each include an interface based on another standard. The memory modules 20 and the card slots 30 may be coupled to the CPU 10 via the chipset 60. Each of the cards CARD is an example of an electronic component. Each of the card slots 30 is an example of an attachment portion to which the corresponding one of the cards CARD is attached. In place of the card slots 30, sockets, connectors, or the like may be attached to the motherboard 110. In this case, electronic components other than the cards CARD are attached to the sockets, the connectors, or the like so as to be detachable. In addition, the cards CARD in the descriptions of FIG. 4 to FIG. 8 are replaced with the other electronic components.

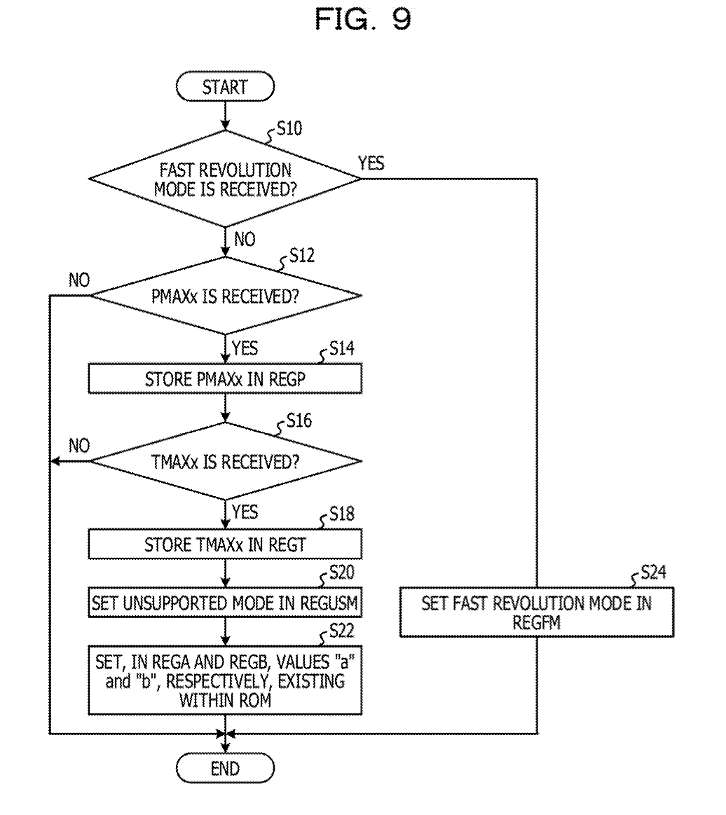

A program such as the BIOS to be started at a time of power-on of the server SV2 or at a time of restarting thereof is stored in the PROM 70. An operation, which is related to control of the number of revolutions of each of the fans 120 and which is included in operations of the BIOS, will be described in FIG. 9.

The BMC 80 executes a management program (firmware F/W), thereby managing operation states of the CPU 10, various memories such as the memory modules 20, the fans 120, a power supply unit not illustrated, and so forth that are mounted in the server SV2. The management program executed by the BMC 80 allocates registers REGA, REGB, REGP, REGT, REGSW, REGFM, and REGUSM to be used for controlling the number of revolutions of each of the fans 120. In other words, the BMC 80 includes the registers REGA, REGB, REGP, REGT, REGSW, REGFM, and REGUSM.

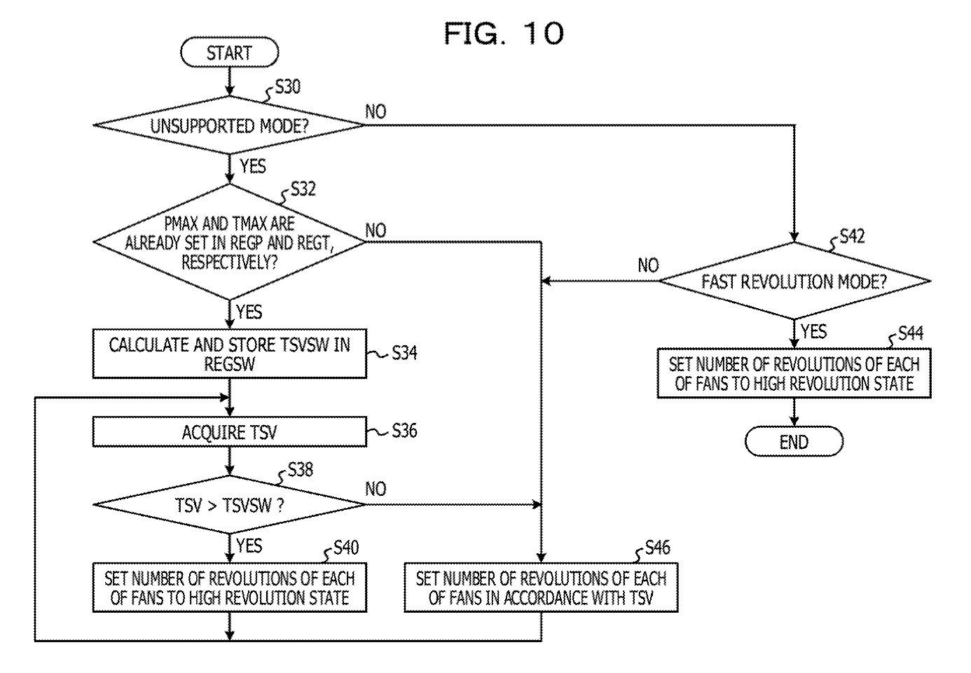

Pieces of information stored in the registers REGA, REGB, REGP, REGT, REGSW, REGFM, and REGUSM will be described in FIG. 9 or FIG. 10. The management program F/W is stored in a memory provided within the BMC 80. An operation, which is related to control of the number of revolutions of each of the fans 120 and which is included in operations of the BMC 80, will be described in FIG. 10. The management program F/W to be executed by the BMC 80 is an example of the control program for the information processing apparatus. An operation of the server SV2, which is realized by the execution of the management program F/W, is an example of the control method for the information processing apparatus.

While not specifically restricted, the PROM 70 and the BMC 80 are coupled to the CPU 10 via the chipset 60.

Each of the fans 120 is attached to the air inlet AIN of the enclosure 100 and introduces outside air into the enclosure 100. The outside air introduced from the air inlet AIN into the enclosure 100 absorbs heat generated by various components mounted on the motherboard 110, thereby being heated. In addition, the heated outside air is released from the exhaust outlet AOUT of the enclosure 100. In other words, heat generated within the enclosure 100 along with the operation of the server SV2 is released to the outside of the enclosure 100 by using an air-cooling method. Each of the fans 120 may be attached to the exhaust outlet AOUT and may release, from the exhaust outlet AOUT, the outside air introduced from the air inlet AIN and heated.

The temperature sensor 130 is provided in an area adjacent to the air inlet AIN and located within the enclosure 100. The temperature sensor 130 detects an outside air temperature serving as a temperature of the outside air introduced into the enclosure 100 and outputs, to the BMC 80, temperature information indicating the detected outside air temperature. The temperature sensor 130 may be provided at a position adjacent to the fans 120 and located on the motherboard 110. Furthermore, the temperature sensor 130 may be provided on the outside of the server SV2, and the BMC 80 may be notified of the outside air temperature detected by the temperature sensor 130, by using a communication line or the like. The temperature sensor 130 is provided within the enclosure 100, thereby enabling the outside air temperature detected by the temperature sensor 130 to be transmitted to the BMC 80 without using the communication line or the like. From this, compared with a case of providing the temperature sensor 130 on the outside of the server SV2, it is possible to simplify a mechanism for detecting the outside air temperature.

The temperature sensor 40 is provided on an exhaust outlet AOUT side of the CPU 10. The temperature sensor 40 detects a temperature of air, which rises mainly due to heat generation of the CPU 10, and outputs, to the BMC 80, temperature information indicating the detected temperature. The temperature sensor 50 is provided on an exhaust outlet AOUT of the memory modules 20. The temperature sensor 50 detects a temperature of air, which rises mainly due to heat generation of the memory modules 20, and outputs, to the BMC 80, temperature information indicating the detected temperature.

Based on the pieces of temperature information received from the temperature sensors 130, 40, and 50, the BMC 80 notifies the fan interface 90 of setting information for setting the number of revolutions of each of the fans 120. Based on the setting information received from the BMC 80, the fan interface 90 sets the number of revolutions of each of the fans 120.

The number of the memory modules 20 mounted in the motherboard 110 is not limited to “4”. The number of the card slots 30 mounted in the motherboard 110 is not limited to “3”. The number of the fans 120 is not limited to “4”. Furthermore, the CPUs 10 may be mounted on the motherboard 110.

By causing the card CARD1 to operate along with the server SV2 in, for example, a state in which the card CARD1 is mounted in the server SV2, the vendor or the like of the server SV2 already confirms that an ambient temperature of the card CARD1 does not exceed an operation-guaranteed temperature of the card CARD1. In the same way, by causing the card CARD2 to operate along with the server SV2 in a state in which the card CARD2 is mounted in the server SV2, the vendor or the like of the server SV2 already confirms that an ambient temperature of the card CARD2 does not exceed an operation-guaranteed temperature of the card CARD2. In other words, the management program F/W of the server SV2 controls the number of revolutions of each of the fans 120 after taking into consideration the ambient temperatures of the cards CARD1 and CARD2 mounted in the server SV2.

On the other hand, the vendor or the like of the server SV2 does not cause the card CARDx to operate along with the server SV2 in a state in which the card CARDx is mounted in the server SV2, and the vendor or the like of the server SV2 does not confirm that an ambient temperature of the card CARDx does not exceed an operation-guaranteed temperature of the card CARDx. In other words, the CARDx is an electronic component for which a relationship between power consumption and a temperature within the enclosure 100 is unknown. Hereinafter, the card CARDx is also called an unsupported card CARDx. In a case where the unsupported card CARDx is mounted in the server SV2 and is caused to operate, an operation of the card CARDx is not guaranteed. Therefore, in order to guarantee the operation of the unsupported card CARDx mounted in the server SV2, the management program F/W executed by the BMC 80 has a function of controlling the number of revolutions of each of the fans 120, based on an electrical characteristic specification of the unsupported card CARDx.

FIG. 3 illustrates an example of control of the number of revolutions in a normal control mode in each of the fans 120 illustrated in FIG. 2. The BMC 80 executes the management program F/W, thereby realizing the control illustrated in FIG. 3. In the normal control mode, in a case where the outside air temperature TSV is less than 25 degrees centigrade, the number of revolutions of each of the fans 120 is set to a low revolution state. In addition, in a case where the outside air temperature TSV is greater than or equal to 35 degrees centigrade, the number of revolutions of each of the fans 120 is set to a high revolution state. The number of revolutions of each of the fans 120 in the low revolution state is, for example, 400 revolutions per minute (rpm). The number of revolutions of each of the fans 120 in the high revolution state is 2400 rpm.

In a case where the outside air temperature TSV is greater than or equal to 25 degrees centigrade and is less than 35 degrees centigrade, the number of revolutions of each of the fans 120 changes from the low revolution state to the high revolution state with an rise in the outside air temperature TSV. In other words, the BMC 80 and the fan interface 90 execute variable control for changing the number of revolutions of each of the fans 120 between the low revolution state and the high revolution state in accordance with the outside air temperature TSV. The maximum value TSVMAX of the outside air temperature, at which the server SV2 normally functions, is 35 degrees centigrade. Therefore, to cause the server SV2 to operate under the outside air temperature TSV exceeding 35 degrees centigrade is not guaranteed.

In a case where the ambient temperature of the CPU 10 or the memory modules, detected by at least one of the temperature sensors 40 and 50 illustrated in FIG. 2, becomes greater than or equal to a restrictive temperature (for example, 50 degrees centigrade), the management program F/W executed by the BMC 80 stops the variable control. In addition, the management program F/W sets the number of revolutions of each of the fans 120 to a value (for example, the high revolution state) for suppressing the ambient temperature of the CPU 10 or the memory modules to a level lower than the restrictive temperature. From this, while executing the variable control of the number of revolutions of each of the fans 120, it is possible to inhibit temperatures of electronic components other than the cards CARD from exceeding the restrictive temperature, the electronic components being mounted in the enclosure 100. In addition, it is possible to improve the reliability of the server SV2. The restrictive temperature (the ambient temperature of, for example, 50 degrees centigrade) is a temperature for suppressing the temperature of the CPU 10 to a level less than or equal to, for example, an operation-guaranteed temperature (for example, 85 degrees centigrade).

FIG. 4 illustrates an example of a relationship between power consumption P of the card CARD1 mounted in the server SV2 illustrated in FIG. 2 and an ambient temperature T of the card CARD1. The characteristics illustrated in FIG. 4 are obtained by an evaluation that causes the card CARD1 to operate along with the server SV2 in a state in which the card CARD1 is mounted in the server SV2. A guaranteed range of the outside air temperature TSV in the server SV2 is, for example, from 5 degrees centigrade to 35 degrees centigrade.

A thick solid line illustrated in FIG. 4 indicates a relationship between the power consumption P and the ambient temperature T of the card CARD1, measured in a case where the server SV2 is caused to operate in a worst-case condition and the card CARD1 is caused to operate in a state in which the card CARD1 is mounted in the server SV2. In other words, the CARD1 is an electronic component for which a relationship between the power consumption P and the temperature T within the enclosure 100 is already known. In the worst-case condition, the server SV2 is caused to operate so that the ambient temperature of the CPU 10, detected by the temperature sensor 40, and the ambient temperature of the memory modules 20, detected by the temperature sensor 50, each become, for example, a maximum value (for example, 50 degrees centigrade).

The ambient temperature T of the card CARD1 is measured by a temperature sensor temporarily attached on the card CARD1 mounted in the server SV2. The temperature sensor may be temporarily attached on a leeward side of the card CARD1 mounted in the server SV2. The ambient temperature T of the card CARD1 may be measured by another measuring equipment such as a thermometer, in place of the temperature sensor. The power consumption P of the card CARD1 is measured by an ammeter attached to a power supply line of, for example, the card slot 30(c).

A double circle illustrated in FIG. 4 indicates worst-case values (maximum power consumption PMAX1 and an operation-guaranteed temperature TMAX1) of electrical characteristic specifications of the card CARD1. The amount of heat generation of the card CARD1 is largest at the maximum power consumption PMAX1. Therefore, if the ambient temperature TMAX of the card CARD1 mounted in the server SV2 is less than or equal to the operation-guaranteed temperature TMAX1 in a case of a maximum specification (35 degrees centigrade) of the outside air temperature TSV and of the maximum power consumption PMAX1, the operation of the card CARD1 within the server SV2 is guaranteed.

A characteristic indicated by the thick solid line is expressed by Expression (1). In other words, Expression (1) is calculated based on measurement results of the power consumption P and the ambient temperature T of the card CARD1. In Expression (1), a symbol “a” indicates a slope of the thick solid line. A symbol “b” indicates the ambient temperature T (a so-called y intercept) of the card CARD1 at an assumed lower limit of the power consumption P.

Ambient Temperature T=a×Power Consumption P+b (1)

A thick dashed line in an area exceeding the maximum power consumption PMAX1 is extrapolated from the thick solid line, based on Expression (1). A characteristic, which is indicated by the thick dashed line and in which the operation of the card CARD1 is not guaranteed, is used in a case where the maximum power consumption of the unsupported card CARDx exceeds the value PMAX1. The slope “a” and the intercept “b” illustrated in Expression (1) are stored in the PROM and are transferred to the registers REGA and REGB, respectively, at a time of starting of the server SV2.

In a case where the outside air temperature TSV is 30 degrees centigrade, it is estimated that the ambient temperature of the card CARD1 mounted in the server SV2 drops 5 degrees, compared with a case where the outside air temperature TSV is 35 degrees centigrade. Therefore, a relationship between the power consumption P and the ambient temperature T of the card CARD1 in a case where the outside air temperature TSV is 30 degrees centigrade is generated by parallel-shifting the thick solid line and the thick dashed line in FIG. 4 to a side lowered by 5 degrees. In the same way, a relationship between the power consumption P and the ambient temperature T of the card CARD1 in a case where the outside air temperature TSV is 25 degrees centigrade is generated by parallel-shifting the thick solid line and the thick dashed line in FIG. 4 to a side lowered by 10 degrees.

The number of revolutions of each of the fans 120 in a case where the outside air temperature TSV is 35 degrees centigrade, 30 degrees centigrade, or 25 degrees centigrade is controlled in accordance with an operation specification in the normal control mode illustrated in FIG. 3. As for the card CARD2 or the like the operation of which is guaranteed in a case of being mounted in the server SV2, characteristics similar to the respective characteristics illustrated in FIG. 4 are acquired based on measurements of the power consumption P and the ambient temperature T. In other words, the CARD2 is an electronic component for which a relationship between power consumption and a temperature within the enclosure 100 is already known. In this embodiment, a line indicating a characteristic of the card CARD2 or the like for which a relationship between the power consumption P and the ambient temperature T within the enclosure 100 is already known is located on an x-axis side, compared with the thick solid line indicating the characteristic of the card CARD1. The characteristic of the card CARD2 is indicated by, for example, a dashed-dotted line. Accordingly, it is determined that the card CARD1 is a worst-case card the ambient temperature T of which becomes the largest.

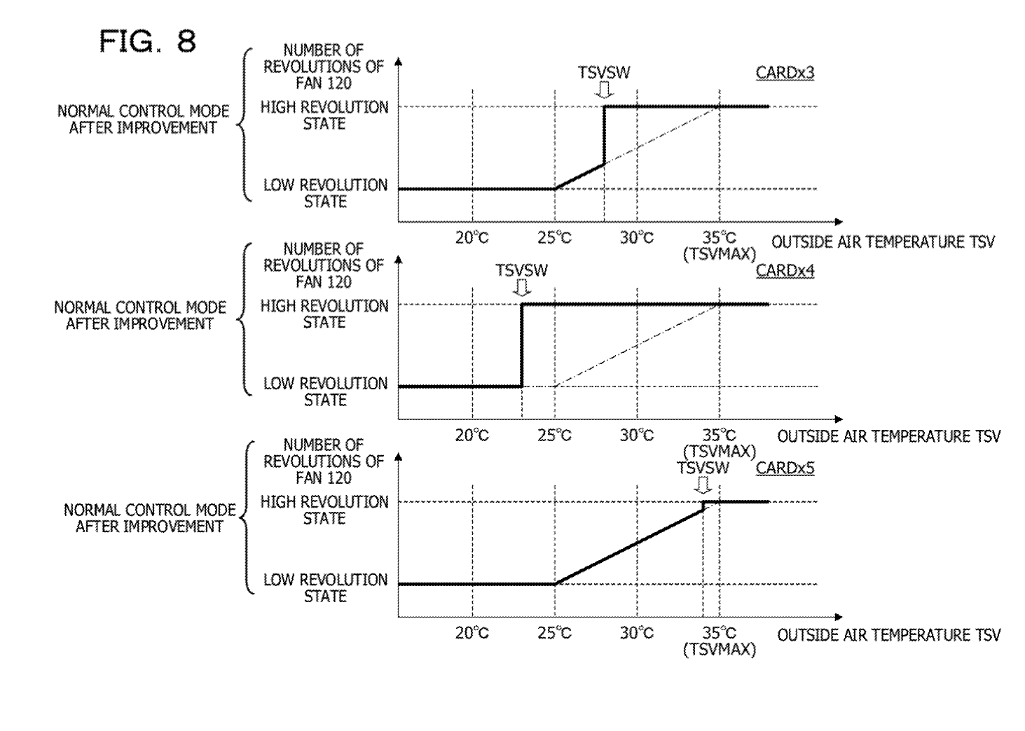

In a case where the unsupported card CARDx for which the power consumption P and the ambient temperature T are not measured is mounted, the server SV2 controls the number of revolutions of each of the fans 120 by using the characteristic of Expression (1), obtained by the evaluation of the card CARD1. Examples of control of the number of revolutions of each of the fans 120, performed by the management program F/W, are illustrated in FIG. 6, FIG. 8, and FIG. 10.

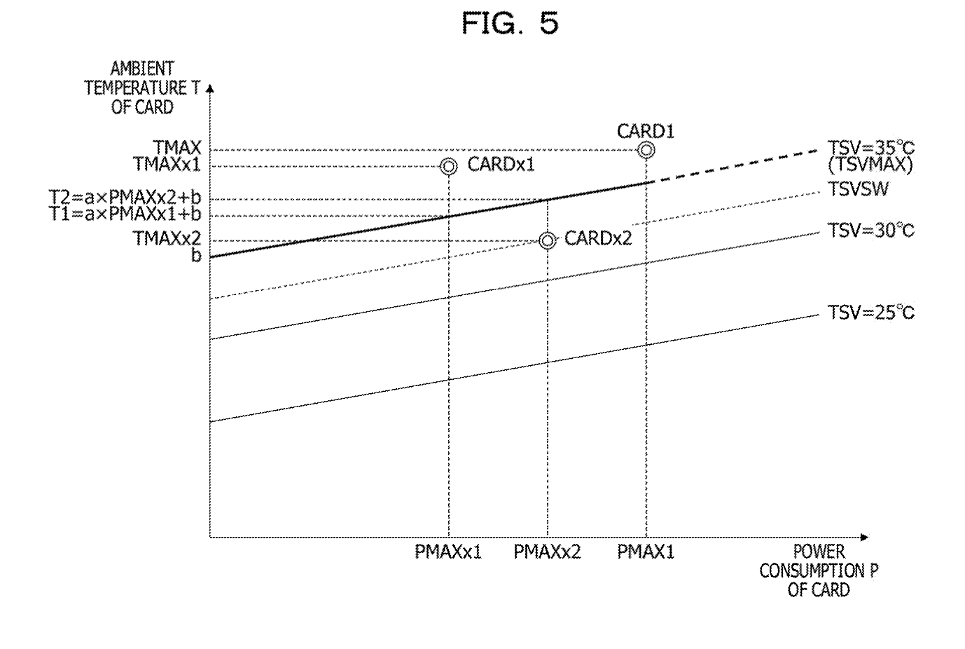

FIG. 5 illustrates examples of electrical characteristic specifications (maximum power consumption and an operation-guaranteed temperature) of each of unsupported cards CARDx (CARDx1 and CARDx2) mounted in the server SV2 illustrated in FIG. 2. The same symbol is assigned to the same element as that in FIG. 4, and the detailed description thereof will be omitted.

The unsupported card CARDx1 has maximum power consumption of PMAXx1 and an operation-guaranteed temperature of TMAXx1. It may be thought that the operation-guaranteed temperature TMAXx1 is a maximum value of an ambient temperature of the card CARDx1 in a case where the electric power of the card CARDx1 is the maximum power consumption PMAXx1. The operation-guaranteed temperature TMAXx1 is higher than an ambient temperature T1 of the card CARD1 in a case where the power consumption of the card CARD1 is the value PMAXx1.

In a case where the outside air temperature TSV is 35 degrees centigrade (TSVMAX) serving as a maximum temperature permissible for the server SV2, there is a possibility that the ambient temperature of the card CARDx1 rises to the value T1 at a maximum. However, the maximum ambient temperature T1 of the card CARDx1 is lower than the operation-guaranteed temperature TMAXx1. In this case, by controlling the number of revolutions of each of the fans 120 in the normal control mode illustrated in FIG. 3, it is possible to suppress the ambient temperature of the card CARDx1 mounted in the server SV2 to a level lower than the operation-guaranteed temperature TMAXx1 and to cause the server SV2 to operate. In other words, it is possible to guarantee the operation of the unsupported card CARDx1 mounted in the server SV2.

In a case of attaching the unsupported card CARDx1 to one of the card slots 30, a user who uses the server SV2 calls a setting screen of the BIOS at a time of starting of the server SV2. In addition, by using input devices such as the keyboard 140 and the mouse 150, the user inputs the maximum power consumption PMAXx1 and the operation-guaranteed temperature TMAXx1 of the card CARDx1. The BIOS stores, in the registers REGP and REGT, the received maximum power consumption PMAXx1 and operation-guaranteed temperature TMAXx1, respectively. The slope “a” and the intercept “b” of Expression (1), which indicate the characteristic of the card CARD1, are preliminarily stored in the PROM 70. The slope “a” and the intercept “b” are stored in REGA and REGB, respectively, by the BIOS at a time of starting of the server SV2.

The management program F/W of the BMC 80, illustrated in FIG. 2, reads the values of the slope “a”, the intercept “b”, and the maximum power consumption PMAXx1 of the card CARDx1, stored in the registers REGA, REGB, and REGP, respectively. In addition, the management program F/W substitutes the read values into Expression (1). In addition, the management program F/W calculates the ambient temperature T1 at the power consumption PMAXx1 in the card CARD1. Next, by using Expression (2), the management program F/W calculates a value obtained by subtracting the operation-guaranteed temperature TMAXx1 of the card CARDx1 from the ambient temperature T1 (=a×PMAXx1+b) and determines whether the calculated value is a negative value. Since the calculated value is the negative value and Expression (2) is satisfied, the management program F/W determines that it is possible to guarantee the operation of the card CARDx1 in the normal control mode.

(a×PMAXx+b)−TMAXx<0 (2)

On the other hand, the unsupported card CARDx2 has maximum power consumption of PMAXx2 and an operation-guaranteed temperature of TMAXx2. It may be thought that the operation-guaranteed temperature TMAXx2 is a maximum value of an ambient temperature that guarantees the operation of the card CARDx2 in a case where the electric power of the card CARDx2 is the maximum power consumption PMAXx2. The operation-guaranteed temperature TMAXx2 is lower than an ambient temperature T2 of the card CARD1 in a case where the power consumption of the card CARD1 is the value PMAXx2. In a case where the outside air temperature TSV is 35 degrees centigrade (TSVMAX), there is a possibility that the ambient temperature of the card CARDx2 rises to the value T2 higher than the operation-guaranteed temperature TMAXx2. Accordingly, in a case of controlling the number of revolutions of each of the fans 120 in the normal control mode illustrated in FIG. 3, the operation of the unsupported card CARDx2 mounted in the server SV2 is not guaranteed.

In the same way as at a time of using the card CARD1x, in a case of attaching the unsupported card CARDx2 to one of the card slots 30, the BIOS receives the maximum power consumption PMAXx2 and the operation-guaranteed temperature TMAXx2 of the card CARDx2. The BIOS stores, in the registers REGP and REGT, the received maximum power consumption PMAXx2 and operation-guaranteed temperature TMAXx2, respectively. The management program F/W substitutes, into the Expression (1), the values of the slope “a”, the intercept “b”, and the maximum power consumption PMAXx2 stored in the registers REGA, REGB, and REGP, respectively, and calculates the ambient temperature T2 at the power consumption PMAXx2 in the card CARD2. Next, by using Expression (2), the management program F/W calculates a value obtained by subtracting the operation-guaranteed temperature TMAXx2 of the card CARDx2 from the ambient temperature T2 (=a×PMAXx2+b). Since the calculated value is not a negative value and Expression (2) is not satisfied, the management program F/W determines that it is difficult to guarantee the operation of the card CARDx2 in the normal control mode.

In this case, by cancelling the normal control mode and forcibly fixing the number of revolutions of each of the fans 120 in the high revolution state, it becomes possible to guarantee the operation of the card CARDx2. However, in a case of continuously setting the number of revolutions of each of the fans 120 to the high revolution state, the power consumption of each of the fans 120 becomes large and the noise of each of the fans 120 becomes loud, compared with a case of controlling the number of revolutions thereof in the normal control mode.

Therefore, by using Expression (3), the management program F/W calculates the switching temperature TSVSW serving as an outside air temperature at which the number of revolutions of each of the fans 120 is forcibly set to a high speed during the normal control mode. TSVMAX is, for example, 35 degrees centigrade. In the card CARDx2, “a×PMAXx+b” in Expression (3) is the value T2, and “TMAXx” in Expression (3) is the operation-guaranteed temperature TMAXx2. As illustrated in Expression (3), the switching temperature TSVSW is a value obtained by subtracting a difference between the value T2 and the value TMAXx2 from the maximum outside air temperature TVXMAX (35 degrees centigrade). The switching temperature TSVSW is a maximum outside air temperature to guarantee that the temperature of the unsupported card CARDx2 attached to one of the card slots 30 does not exceed the operation-guaranteed temperature TMAXx2.

TSVSW=TSVMAX−(a×PMAXx+b−TMAXx) (3)

As illustrated in Expression (3), by using the maximum outside air temperature TVXMAX, the temperature T2, and the operation-guaranteed temperature TMAXx, the switching temperature TSVSW may be calculated based only on subtraction. The temperature T2 (=a×PMAXx+b) may be calculated based on multiplication and addition.

In FIG. 5, the switching temperature TSVSW to guarantee the operation of the card CARDx2 is 32.5 degrees centigrade. This indicates that if the outside air temperature TSV is less than or equal to 32.5 degrees centigrade, it is possible to maintain the ambient temperature T of the card CARDx2 at a level less than or equal to the operation-guaranteed temperature TMAXx2, by controlling the number of revolutions of each of the fans 120 in the normal control mode. Therefore, in a case where the outside air temperature TSV exceeds the switching temperature TSVSW, the server SV2 stops the control of the numbers of revolutions, performed in the normal control mode, and sets the number of revolutions of each of the fans 120 to the high revolution state. In other words, in a case where the outside air temperature TSV exceeds the switching temperature TSVSW, the server SV2 sets the number of revolutions of each of the fans 120 to a value for suppressing the temperature of the card CARDx2 to a level less than or equal to the operation-guaranteed temperature TMAXx2. In a case where the outside air temperature TSV exceeds the switching temperature TSVSW, the BMC 80 sets the number of revolutions of each of the fans 120 to a maximum value (the high revolution state) while not setting to a state between the low revolution state and the high revolution state. By maximizing a capacity for cooling the card CARDx2 mounted in the server SV2, it is possible to inhibit the temperature T from exceeding the operation-guaranteed temperature TMAXx2 in the unsupported card CARDx2.

Furthermore, compared with a case of fixing the number of revolutions of each of the fans 120 in the high revolution state regardless of the outside air temperature TSV, it is possible to inhibit the ambient temperature of the card CARDx2 from exceeding the operation-guaranteed temperature TMAXx2 while suppressing an increase in the power consumption of each of the fans 120. In other words, it is possible to guarantee the operation of the card CARDx2 mounted in the server SV2 while suppressing an increase in the power consumption of the server SV2.

The BMC 80 is an example of a calculation unit to calculate, based on the ambient temperature T2 of the card CARD1 and the operation-guaranteed temperature TMAXx2 of the card CARD2x, the switching temperature TSVSW serving as a maximum outside air temperature able to guarantee the operation of the card CARDx2 attached to one of the card slots 30. The BMC 80 is an example of a fan control unit to stop control based on the normal control mode and to set the number of revolutions of each of the fans 120 to the high revolution state in a case where the outside air temperature TSV exceeds the switching temperature TSVSW during attachment of the card CARDx2 to one of the card slots 30.

FIG. 6 illustrates an example of control of the number of revolutions of each of the fans 120 of the server SV2 in which the card CARDx2 illustrated in FIG. 5 is mounted. A dashed-dotted line illustrated in FIG. 6 indicates a change in the number of revolutions in the normal control mode illustrated in FIG. 3. In a case where the outside air temperature TSV detected by the temperature sensor 130 is less than or equal to the switching temperature TSVSW, the server SV2 controls the number of revolutions of each of the fans 120 in the normal control mode illustrated in FIG. 3. On the other hand, in a case where the outside air temperature TSV detected by the temperature sensor 130 exceeds the switching temperature TSVSW, the server SV2 sets the number of revolutions of each of the fans 120 to the high revolution state. As illustrated in lower side of FIG. 6, in a case where a fast revolution mode is specified at a time of starting, the server SV2 fixes the number of revolutions of each of the fans 120 in the high revolution state, regardless of the outside air temperature TSV.

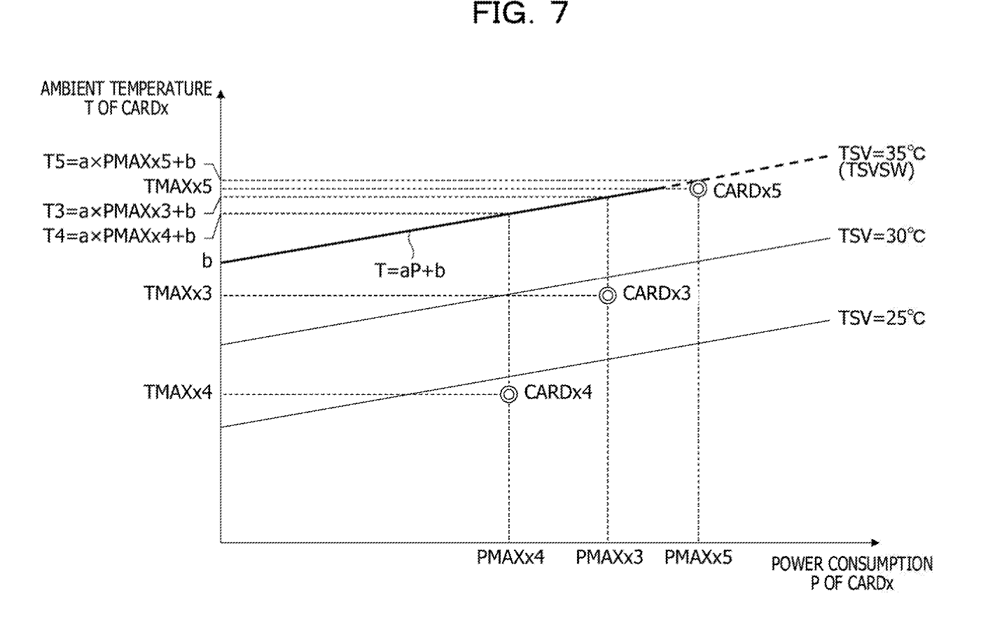

FIG. 7 illustrates examples of electrical characteristic specifications (maximum power consumption and an operation-guaranteed temperature) of each of other unsupported cards (CARDx3, CARDx4, and CARDx5) mounted in the server SV2 illustrated in FIG. 2. The same symbol is assigned to the same element as that in FIG. 3 or FIG. 5, and the detailed description thereof will be omitted. A thick solid line and a thick dashed line illustrated in FIG. 7 indicate characteristics calculated based on measurement results of the power consumption P and the ambient temperature T of the card CARD1 and have the same characteristics as those of the respective thick solid line and thick dashed line illustrated in FIG. 4.

The unsupported card CARDx3 has maximum power consumption of PMAXx3 and an operation-guaranteed temperature of TMAXx3. The operation-guaranteed temperature TMAXx3 is lower than an ambient temperature T3 at the maximum power consumption PMAXx3 in the card CARD1 indicated by both the thick solid line and the thick dashed line. The unsupported card CARDx4 has maximum power consumption of PMAXx4 and an operation-guaranteed temperature of TMAXx4. The operation-guaranteed temperature TMAXx4 is lower than an ambient temperature T4 at the maximum power consumption PMAXx4 in the card CARD1 indicated by both the thick solid line and the thick dashed line. The unsupported card CARDx5 has maximum power consumption of PMAXx5 and an operation-guaranteed temperature of TMAXx5. The operation-guaranteed temperature TMAXx5 is lower than an ambient temperature T5 at the maximum power consumption PMAXx5 in the card CARD1 indicated by both the thick solid line and the thick dashed line. The ambient temperature T3 (or T4 or T5) of the card CARD1 is calculated by substituting the maximum power consumption PMAXx3 (or PMAXx4 or PMAXx5) into Expression (1).

None of a relationship between the operation-guaranteed temperature TMAXx3 and ambient temperature T3, a relationship between the operation-guaranteed temperature TMAXx4 and the ambient temperature T4, and a relationship between the operation-guaranteed temperature TMAXx5 and the ambient temperature T5 satisfies Expression (2). Therefore, none of operations of the respective unsupported cards CARDx3, CARDx4, and CARDx5 mounted in the server SV2 is guaranteed.

Therefore, regarding the card CARDx3 (or CARDx4 or CARDx5), by using Expression (3), the BMC 80 calculates the switching temperature TSVSW at which the number of revolutions of each of the fans 120 is forcibly set to a high speed during the normal control mode. The calculated switching temperatures TSVSW of the cards CARDx3, CARDx4, and CARDx5 are 28 degrees centigrade, 24 degrees centigrade, and 34 degrees centigrade, respectively.

FIG. 8 illustrates examples of control of the number of revolutions of each of the fans 120 of the server SV2 in which the unsupported cards CARDx3, CARDx4, and CARDx5, respectively, illustrated in FIG. 7 are mounted.

In a case where the outside air temperature TSV exceeds the switching temperature TSVSW calculated based on the maximum power consumption PMAXx3 and the operation-guaranteed temperature TMAXx3 of the card CARDx3, the server SV2 in which the card CARDx3 is mounted sets the number of revolutions of each of the fans 120 to the high revolution state. In a case where the outside air temperature TSV exceeds the switching temperature TSVSW calculated based on the maximum power consumption PMAXx4 and the operation-guaranteed temperature TMAXx4 of the card CARDx4, the server SV2 in which the card CARDx4 is mounted sets the number of revolutions of each of the fans 120 to the high revolution state. In a case where the outside air temperature TSV exceeds the switching temperature TSVSW calculated based on the maximum power consumption PMAXx5 and the operation-guaranteed temperature TMAXx5 of the card CARDx5, the server SV2 in which the card CARDx5 is mounted sets the number of revolutions of each of the fans 120 to the high revolution state.

FIG. 9 illustrates an example of an operation of the BIOS illustrated in FIG. 2. In other words, FIG. 9 illustrates an example of the control method for the information processing apparatus and an example of the control program for the information processing apparatus. A flow illustrated in FIG. 9 is executed by the BIOS in a case where a setting of the BIOS is specified at a time of starting of the server SV2. A predetermined key such as an “F2” key or a “Delete” key of the keyboard 140 is pressed down at a time of, for example, starting of the server SV2, thereby displaying a setting screen of the BIOS on the display 160. In addition, based on information input via the keyboard 140 by a user, who uses the server SV2, or the like, the flow illustrated in FIG. 9 is executed. Instead of being executed by the BIOS, the flow illustrated in FIG. 9 may be executed within an operation flow of the BMC 80 illustrated in FIG. 10. In this case, the flow illustrated in FIG. 9 is inserted before S30 illustrated in FIG. 10.

First, in S10, the BIOS determines whether or not information indicating the fast revolution mode is received via the keyboard 140. In a case where the information indicating the fast revolution mode is received, the processing is shifted to S24, and in a case where no information indicating the fast revolution mode is received, the processing is shifted to S12.

In S12, the BIOS determines whether or not information indicating the maximum power consumption PMAXx of the unsupported card CARDx attached to one of the card slots 30 of the server SV2 is received via the keyboard 140. In a case where the information indicating the maximum power consumption PMAXx is received, the processing is shifted to S14, and in a case where no information indicating the maximum power consumption PMAXx is received, the processing is terminated.

In S14, the BIOS stores the received maximum power consumption PMAXx in the register REGP and shifts the processing to S16. In S16, the BIOS determines whether or not information indicating the operation-guaranteed temperature TMAXx of the unsupported card CARDx attached to one of the card slots 30 of the server SV2 is received via the keyboard 140. In a case where the information indicating the operation-guaranteed temperature TMAXx is received, the processing is shifted to S18. On the other hand, in a case where no information indicating the operation-guaranteed temperature TMAXx is received, the processing is terminated.

In a case where the unsupported cards CARDx are attached to the respective card slots 30, the maximum power consumption PMAXx and the operation-guaranteed temperature TMAXx of one of the cards CARDx are input, the relevant card CARDx having a severe operating condition. In a case where the cards CARDx3, CARDx4, and CARDx5 illustrated in, for example, FIG. 7 are attached to the respective card slots 30, the maximum power consumption PMAXx4 and the operation-guaranteed temperature TMAXx4 of the card CARDx4 are input.

In S18, the BIOS stores the received operation-guaranteed temperature TMAXx in the register REGT and shifts the processing to S20.

In S20, the BIOS sets, in the register REGUSM, information indicating an unsupported mode and shifts the processing to S22. In S22, the BIOS reads, from the PROM, values of the slope “a” and the intercept “b” and stores the read value of the slope “a” in the register REGA. In addition, the BIOS stores the read value of the intercept “b” in the register REGB and terminates the processing.

On the other hand, in S24, the BIOS sets, in the register REGFM, the information indicating the fast revolution mode and terminates the processing. Since the unsupported mode and the fast revolution mode are set in a mutually exclusive manner, the BMC 80 may include a common register in which one of the unsupported mode and the fast revolution mode is set, in place of the registers REGUSM and REGFM.

FIG. 10 illustrates an example of an operation of the BMC 80 illustrated in FIG. 2. The BMC 80 executes the management program F/W, thereby realizing the operation illustrated in FIG. 10. In other words, FIG. 10 illustrates an example of the control method for the information processing apparatus and an example of the control program for the information processing apparatus.

First, in S30, the BMC 80 determines, based on a value of the register REGUSM, whether or not the unsupported mode is set. In a case where the unsupported mode is set, the processing is shifted to S32, and in a case where the unsupported mode is not set, the processing is shifted to S42.

In S32, the BMC 80 determines whether or not the maximum power consumption PMAXx and the operation-guaranteed temperature TMAXx are stored in the registers REGP and REGT, respectively. In a case where the maximum power consumption PMAXx and the operation-guaranteed temperature TMAXx are stored in the registers REGP and REGT, respectively, it is determined that an unsupported card CARDx is attached to one of the card slots 30 of the server SV2, and the processing is shifted to S34. In a case where one of the maximum power consumption PMAXx and the operation-guaranteed temperature TMAXx is not stored in the register REGP or REGT, it is determined that no unsupported card CARDx is attached to the card slots 30 of the server SV2, and the processing is shifted to S46.

In S34, by using Expression (1), Expression (2), and Expression (3), the BMC 80 calculates the switching temperature TSVSW. In addition, the BMC 80 stores the calculated switching temperature TSVSW in the register REGSW. By providing the registers REGA, REGB, REGP, REGT, REGFM, and REGUSM in the BMC 80, it is possible for the BIOS to transmit information to the BMC 80 without omission. Next, in S36, the BMC 80 acquires the outside air temperature TSV from the temperature sensor 130. S36 is performed at a predetermined interval, for example, 500-milliseconds interval or 1-second interval.

Next, in S38, the BMC 80 determines whether or not the outside air temperature TSV is higher than the switching temperature TSVSW. In a case where the outside air temperature TSV is higher than the switching temperature TSVSW, the processing is shifted to S40, and in a case where the outside air temperature TSV is less than or equal to the switching temperature TSVSW, the processing is shifted to S46. In S40, the BMC 80 sets the number of revolutions of each of the fans 120 to the high revolution state via the fan interface 90 and returns the processing to S36.

On the other hand, in a case where the unsupported mode is not set, in S42 the BMC 80 determines, based on a value of the register REGFM, whether or not the fast revolution mode is set. In a case where the fast revolution mode is set, the processing is shifted to S44, and in a case where the fast revolution mode is not set, the processing is shifted to S46.

In S44, the BMC 80 sets, to the high revolution state, the number of revolutions of each of the fans 120 via the fan interface 90 and terminates the processing. In other words, in a case where the fast revolution mode is set, the number of revolutions of each of the fans 120 is maintained in the high revolution state, regardless of a temperature detected by the temperature sensor 130, 50, or and 40.

In S46, as illustrated in FIG. 3, the BMC 80 sets the number of revolutions of each of the fans 120 in accordance with the outside air temperature TSV and returns the processing to S36.

As above, in embodiments illustrated in FIG. 2 to FIG. 10, the same advantage as that of the embodiment illustrated in FIG. 1 may be obtained. In other words, compared with a case of fixing, based on mounting of the unsupported card CARDx in the server SV2, the number of revolutions of each of the fans 120 at a maximum value, it is possible to reduce the power consumption of each of the fans 120, and it is possible to reduce the noise of each of the fans 120. As a result, in a case where an unsupported card CARDx is mounted in the server SV2, it is possible to suppress an increase in the power consumption of the server SV2, and it is possible to suppress an increase in the noise of the server SV2.

Furthermore, in the embodiments illustrated in FIG. 2 to FIG. 10, by using Expression (1), Expression (2), and Expression (3), the management program F/W of the BMC 80 is able to calculate the switching temperature TSVSW, based only on multiplication and addition (subtraction). In a case where a value obtained by subtracting the operation-guaranteed temperature TMAXx1 of the card CARDx1 from the ambient temperature T1 (=a×PMAXx1+b) is a negative value and Expression (2) is satisfied, the management program F/W controls the number of revolutions of each of the fans 120 in the normal control mode. From this, it is possible to suppress the ambient temperature of the unsupported card CARDx1 mounted in the server SV2 to a level lower than the operation-guaranteed temperature TMAXx1 and to cause the server SV2 to operate.

The temperature sensor 130 is provided within the enclosure 100, thereby enabling the outside air temperature detected by the temperature sensor 130 to be transmitted to the BMC 80 without using the communication line or the like. From this, compared with a case of providing the temperature sensor 130 on the outside of the server SV2, it is possible to simplify a mechanism for detecting the outside air temperature. By providing the registers REGA, REGB, REGP, REGT, REGFM, and REGUSM in the BMC 80, it is possible for the BIOS to transmit information to the BMC 80 without omission. In a case where a temperature detected by the temperature sensor 40 or 50 becomes greater than or equal to a restrictive temperature (for example, 50 degrees centigrade), the variable control is stopped, and the number of revolutions of each of the fans 120 is set to, for example, the high revolution state. From this, while executing the variable control of the number of revolutions of each of the fans 120, it is possible to inhibit the CPU 10 or the like from exceeding the restrictive temperature. As a result, it is possible to improve the reliability of the server SV2.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A control method executed by a processor included in an information processing apparatus, the control method comprising:
calculating a switching temperature indicating a maximum outside air temperature at which a temperature of the unknown electronic component attached within an enclosure does not exceed the operation-guaranteed temperature, based on a temperature of an electronic component for which a relationship between power consumption and a temperature of the electronic component is already known, the temperature of the electronic component corresponding to maximum power consumption of an electronic component for which a relationship between power consumption and the temperature of the electronic component is unknown, and on an operation-guaranteed temperature of the unknown electronic component; and
setting the number of revolutions of a fan to introduce outside air into the enclosure to a value for suppressing the temperature of the unknown electronic component to a level less than or equal to the operation-guaranteed temperature, when an outside air temperature exceeds the switching temperature during attachment of the unknown electronic component within the enclosure.

2. The control method according to claim 1, further comprising:
executing control for changing, in accordance with the outside air temperature, the number of revolutions of the fan when the outside air temperature does not exceed the switching temperature during attachment of the unknown electronic component within the enclosure; and
stopping the control for changing, in accordance with the outside air temperature, the number of revolutions of the fan when the outside air temperature exceeds the switching temperature during attachment of the unknown electronic component within the enclosure.

3. The control method according to claim 1, further comprising:
controlling the fan so that the number of revolutions of the fan changes, in accordance with the outside air temperature, between a first revolution state and a second revolution state in which the number of revolutions is greater than that in the first revolution state, when the outside air temperature does not exceed the switching temperature during attachment of the unknown electronic component within the enclosure,
wherein the setting sets the number of revolutions of the fan to the second revolution state when the outside air temperature exceeds the switching temperature during attachment of the unknown electronic component within the enclosure.

4. The control method according to claim 3, wherein the controlling includes:
controlling the fan so that the fan operates in the first revolution state, when the outside air temperature is less than a first temperature lower than the switching temperature, and
controlling the fan so that the fan operates in the second revolution state, when the outside air temperature does not exceed the switching temperature and is greater than or equal to a second temperature higher than the first temperature.

5. The control method according to claim 1,
wherein the calculating includes calculating the switching temperature by subtracting a difference between the temperature of the known electronic component corresponding to the maximum power consumption and the operation-guaranteed temperature of the unknown electronic component from a maximum value of the outside air temperature permissible for the information processing apparatus.

6. The control method according to claim 1, further comprising:
executing, regardless of the calculated switching temperature, control for changing, in accordance with the outside air temperature, the number of revolutions of the fan, when the difference is a negative value.

7. The control method according to claim 1, further comprising:
stopping control for changing, in accordance with the outside air temperature, the number of revolutions of the fan, when an ambient temperature of another electronic component provided within the enclosure becomes greater than or equal to a restrictive temperature for maintaining the temperature of the other electronic component at a level less than or equal to an operation-guaranteed temperature; and
setting the number of revolutions of the fan to a value for suppressing the ambient temperature to a level lower than the restrictive temperature.

8. The control method according to claim 1,
wherein the outside air temperature is measured by a temperature sensor provided on a motherboard which is located within the enclosure.

9. An information processing apparatus, comprising:
a fan that introduces outside air into an enclosure of the information processing apparatus; and
a processor that controls the fan and that is configured to:
calculate a switching temperature indicating a maximum outside air temperature at which a temperature of the unknown electronic component attached within an enclosure does not exceed the operation-guaranteed temperature, based on a temperature of an electronic component for which a relationship between power consumption and a temperature of the electronic component is already known, the temperature of the electronic component corresponding to maximum power consumption of an electronic component for which a relationship between power consumption and the temperature of the electronic component is unknown, and on an operation-guaranteed temperature of the unknown electronic component, and
set the number of revolutions of a fan to introduce outside air into the enclosure to a value for suppressing the temperature of the unknown electronic component to a level less than or equal to the operation-guaranteed temperature, when an outside air temperature exceeds the switching temperature during attachment of the unknown electronic component within the enclosure.

10. The information processing apparatus according to claim 9, wherein the processor is configured to:
execute control for changing, in accordance with the outside air temperature, the number of revolutions of the fan when the outside air temperature does not exceed the switching temperature during attachment of the unknown electronic component within the enclosure, and
stop the control for changing, in accordance with the outside air temperature, the number of revolutions of the fan when the outside air temperature exceeds the switching temperature during attachment of the unknown electronic component within the enclosure.

11. The information processing apparatus according to claim 9, wherein the processor is configured to:
control the fan so that the number of revolutions of the fan changes, in accordance with the outside air temperature, between a first revolution state and a second revolution state in which the number of revolutions is greater than that in the first revolution state, when the outside air temperature does not exceed the switching temperature during attachment of the unknown electronic component within the enclosure, and
set the number of revolutions of the fan to the second revolution state when the outside air temperature exceeds the switching temperature during attachment of the unknown electronic component within the enclosure.

12. A non-transitory computer-readable recording medium storing a program that causes a processor included in an information processing apparatus to execute a process, the process comprising:
calculating a switching temperature indicating a maximum outside air temperature at which a temperature of the unknown electronic component attached within an enclosure does not exceed the operation-guaranteed temperature, based on a temperature of an electronic component for which a relationship between power consumption and a temperature of the electronic component is already known, the temperature of the electronic component corresponding to maximum power consumption of an electronic component for which a relationship between power consumption and the temperature of the electronic component is unknown, and on an operation-guaranteed temperature of the unknown electronic component; and
setting the number of revolutions of a fan to introduce outside air into the enclosure to a value for suppressing the temperature of the unknown electronic component to a level less than or equal to the operation-guaranteed temperature, when an outside air temperature exceeds the switching temperature during attachment of the unknown electronic component within the enclosure.
